(19) United States
(12) Patent Application Publication
(10) Pub. No.: US 2022/0055444 A1
(43) Pub. Date: Feb. 24, 2022

(54) HEATING VENTILATION AND AIR-CONDITIONING SYSTEM

(71) Applicant: Valeo North America, Inc., Troy, MI (US)

(72) Inventors: Earl Buckman, Troy, MI (US); Darshan Parikh, Troy, MI (US); Sally Dagher, Troy, MI (US); Steven Hruska, Troy, MI (US); Nestor Ismael Varela Santoyo, Toluca (MX); Philippe Pierres, Le Mesnil Saint-Denis (FR)

(73) Assignee: Valeo North America, Inc., Troy, MI (US)

(21) Appl. No.: 16/998,357

(22) Filed: Aug. 20, 2020

(51) Int. Cl. B60H 1/00

(52) U.S. Cl. CPC B60H 1/00678; B60H 1/00842; B60H 1/00807; B60H 2001/00092; B60H 1/00021; B60H 1/00514; B60H 1/00785

(57) ABSTRACT

A Heating, Ventilation, and Air-Conditioning unit for a vehicle is provided. The HVAC unit comprises a housing, a first inlet, a second inlet first flap, and a third door. The first flap having a first door and a second door, attached to the first inlet. The first door is angularly movable with respect to the second door and adapted to move between a first position and a second position to open and close the first inlet. Further, the second door is angularly movable with respect to the first door and adapted to move between the first position and a third position to open and close air passage between the first inlet and the second inlet. The third door rotatably connected in the second inlet, and is movable between a closed position where the second inlet is closed and at least partially open position where the second inlet is partially open.

### FIELD OF THE INVENTION

The present invention generally relates to a Heating Ventilation and Air-Conditioning (HVAC) system, more particularly, to a Recirculation Air Management (RAM) in the HVAC system.

### BACKGROUND

Generally, Heating Ventilation and Air-Conditioning (HVAC) systems are installed in a vehicle to provide comfort driving to driver and passengers. The HVAC system either provides hot or cold air to the passenger's cabin depending on the selected mode. Further, the HVAC system is defined with two modes such as a fresh air mode, and a recirculation air mode. In the fresh air mode, the HVAC housing may receive ambient air from the atmospheric through a fresh air inlet. In the recirculation air mode, the air being recirculated from the passenger's cabin to the HVAC housing through a recirculation air inlet. The recirculation air mode is provided in the HVAC to reduce energy consumption of the HVAC. For example, while the vehicle in colder region, the fresh air is very cold, so that the HVAC may consume more energy to provide hot air to the passenger's cabin. In such cases, the recirculated air is provided back to the HVAC that have higher temperature than of the fresh air, so the HVAC may consumes may less energy than the HVAC operating in the fresh air mode. However, there is a problem while using the HVAC in the recirculation mode, which is frosting in doors and windshields due to the humidity content in the recirculation air. Normally, the recirculated air contains humidity due to presence of passengers, so doors and windshields are frosted and affects visibility of the road. To avoid such phenomenon, a partial recirculation air mode is provided in the HVAC system. In such mode, the fresh air inlet and the recirculation air inlet are partially opened to mix the fresh air with the recirculation air in the HVAC, so possibly avoiding frosting of the doors and windshields. However, in such partial recirculation air mode, there is a possibility of flowing the fresh air into the recirculation outlet, which affect performance of the HVAC and invite the above-mentioned problems.

Accordingly, there remains a need for a smart HVAC system that avoid frosting issues while the HVAC system operates in the recirculation air mode. Further, there remains a need for a Recirculation Air Management (RAM) for a HVAC system.

### SUMMARY OF THE INVENTION

In the present description, some elements or parameters may be indexed, such as a first element and a second element. In this case, unless stated otherwise, this indexation is only meant to differentiate and name elements which are similar but not identical. No idea of priority should be inferred from such indexation, as these terms may be switched without betraying the invention. Additionally, this indexation does not imply any order in mounting or use of the elements of the invention.

In view of the foregoing, an embodiment of the invention herein provides a Heating, Ventilation, and Air-Conditioning unit for a vehicle. The HVAC unit comprises a housing, a first inlet, a second inlet, at least one first flap, and a third door. The first inlet is provided in the housing for enabling a first airflow into the housing. The second inlet is provided in the housing for enabling a second airflow into the housing. The at least one first flap having a first door and a second door, attached to the first inlet. The first door is angularly movable with respect to the second door and adapted to move between a first position and a second position to open and close the first inlet. Further, the second door is angularly movable with respect to the first door and adapted to move between the first position and a third position to open and close air passage between the first inlet and the second inlet. The at least one third door rotatably connected in the second inlet. Further, the at least one third door is movable between a closed position where the second inlet is closed and at least partially open position where the second inlet is partially open.

In one embodiment, the first door and the second door are barrel doors that have a same axis of rotation.

In another embodiment, the at least one third door is a butterfly door.

Further, the movement of the at least one third door is based on humidity level of passenger's cabin of the vehicle.

Further, the first door of the at least one first flap is in the second position and the at least one third door is in the open position when the Heating, Ventilation, and Air-Conditioning unit defining a recirculation air mode.

Further, the first door of the at least one first flap is in the first position and the at last one third door is in the closed position when the Heating, Ventilation, and Air-Conditioning unit defining a fresh air mode.

Further, the first door of at least one first flap is in the first position, the second door of the at least one first flap is in the third position and the at least one third door is in partially open position when the Heating, Ventilation, and Air-Conditioning unit defining a partial-recirculation air mode.

In one embodiment, the first door and the second door of the at least one first flap are overlap with each other when the both first door and the second door of the at least one first flap is in the first position.

In another embodiment, the angular movement of the at least one first flap is based on a temperature of the atmospheric air.

Further, the second inlet is juxtaposed to the first inlet.

Further, the HVAC unit comprising a blower adapted to receive air from at least one of the first inlet and the second inlet, a humidity sensor adapted to measure humidity level of the vehicle compartment, and a temperature sensor adapted to measure temperature of the atmospheric air.

Furthermore, the HVAC unit comprising an electronic control unit adapted to receive the humidity and temperature from the respective humidity sensor and temperature sensor and dynamically control the at least one first flap and the at least one third door.

### BRIEF DESCRIPTION OF THE DRAWINGS

Other characteristics, details and advantages of the invention can be inferred from the description of the invention hereunder. A more complete appreciation of the invention and many of the attendant advantages thereof will be readily obtained as the same becomes better understood by reference to the following detailed description when considered in connection with the accompanying figures, wherein:

FIG. 1 illustrates a schematic view of a HVAC unit of a vehicle, in accordance with an embodiment of the present invention;

FIG. 2A illustrates a schematic view of the HVAC unit of FIG. 1 when the HVAC unit is operating in a fresh air mode, in accordance with an embodiment of the present invention;

FIG. 2B illustrates a schematic view of the HVAC unit of FIG. 1 when the HVAC unit is operating in a recirculation air mode, in accordance with an embodiment of the present invention; and

FIGS. 2C and 2D illustrate schematic view of the HVAC unit of FIG. 1 when the HVAC unit is operating in a partial-recirculation air mode, in accordance with an embodiment of the present invention.

It must be noted that the figures disclose the invention in a detailed enough way to be implemented, the figures helping to better define the invention if needs be. The invention should however not be limited to the embodiment disclosed in the description.

### DETAILED DESCRIPTION

The present invention relates to a Heating, Ventilation, Air-conditioning (HVAC) system, hereinafter referred to as HVAC system, for a vehicle. The HVAC system may be provided for the recirculation air management (RAM). The HVAC system may operate in three modes, such as a fresh air mode, a recirculation air mode, and a partial-recirculation air mode. To avoid frosting of windshields and doors of the vehicle during the recirculation air mode, the partial-recirculation air mode is provided in the HVAC system. As a fresh air inlet and a recirculation air inlet are in open position during the partial-recirculation air mode, there is a possibility that the fresh air from the fresh air inlet can directly flow back into the recirculation air inlet due to the pressure difference between the fresh air and the recirculation air. To avoid such scenario, a fresh air inlet flap and a recirculation air inlet door are designed in such a way that the fresh air inlet flap block an air passage between the fresh air inlet and the recirculation air inlet during the HVAC operating in the partial-recirculation air mode.

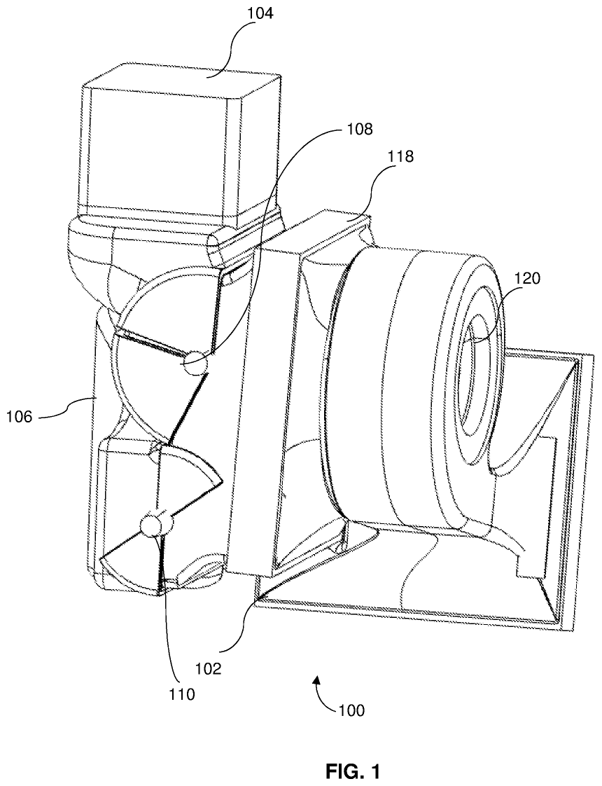

FIG. 1 illustrates a schematic view of a HVAC unit 100 of a vehicle, in accordance with an embodiment of the present invention. The HVAC unit 100 may include a housing 102 adapted to accommodate various elements such flaps, doors, filters and blowers. In one example, the HVAC unit 100 includes the housing 100, a first inlet 104, and a second inlet 106. The first inlet 104 can be a fresh air inlet, and the second inlet 106 can be a recirculation air inlet. In one embodiment, the first inlet 104 and the second inlet 106 are juxtaposed to each other. The first inlet 104 is defined in the housing 102 to provide a first airflow to the housing 102, and the second inlet 106 is defined in the housing 102 to provide a second airflow to the housing 102. In one embodiment, the first airflow is a fresh air/ambient air from atmosphere and the second airflow is a recirculated air from the passenger's cabin of the vehicle. Further, a pair of diverting flaps or doors is provided in the first inlet 104 and the second inlet 106 to control the first airflow and the second airflow. In one example, the HVAC unit 100 includes at least one first flap 108 having a first door 108A, and a second door 108B provided in the first inlet 104 to control the first airflow. In this example, the first door 108A may open and close the first inlet 104 and the second door 108B may open and close an air passage between the first inlet 104 and the second inlet 106. In one embodiment, the first door 108A is a coaxial to the second door 108B. In another embodiment, the first door 108A is concentric to the second door 108B and having same axis of rotation. The first door 108A is angularly movable with respect to the second door 108B. In one example, the first door 108A is angularly movable between a first position 112 and a second position 114 to open and close the first inlet 104 respectively. In first position 112, the first door 108A may allow the first airflow into the housing 102. In second position 114, the first door 108A may block the first airflow entering the housing 102. Although the first door 108A moves between the first position 112 and the second position 114 to open and close the first inlet 104 respectively, it is possible to position the first door 108A in between the first position 112 and the second position 114 to partially close the first inlet 104.

In this example, the second door 108A is angularly movable between the first position 112 and a third position 116 to open and close the air passage between the first inlet 104 and the second inlet 106 respectively. In first position 112, the second door 108B may allow any airflow between the first inlet 104 and the second inlet 106, whereas, the second door 108B may block an airflow between the first inlet 104 and the second inlet 106 when the second door 108B is in the third position 116. Although the second door 108B moves between the first position 112 and the third position 116 to open and close the air passage, it is possible to position the second door 108B in between the first position 112 and the third position 114 to partially close the air passage between the first inlet 104 and the second inlet 106. In one embodiment, the first door 108A and the second door 108B are barrel doors having a same axis of rotation.

The HVAC unit 100 further includes a third door 110 rotatably connected to the second inlet 106 defined in the housing 102. The third door 110 is adapted to control the second airflow flowing from the second inlet 106. The third door 110 is adapted to close the second inlet 106, and partially open the second inlet 106. Further, it is possible for the third door 110 to open the second inlet 106 completely to allow the second airflow into the housing 102. In one embodiment, the third door 110 is a butterfly door, which is angularly movable to control the second airflow to the housing 102. In one example, movement of the third door 110 is based on humidity level of the passenger's cabin of the vehicle. The HVAC unit 100 further includes a filter 118 and a blower 120 provided in a downstream to the first inlet 104 and the second inlet 106. The filter 118 is provided in between the blower 120 and the first and second inlets 104, 106 to filter the airflow received from the first inlet 104 and the second inlet 106. The blower 120 is adapted to draw mixed air of the first and second airflow and provides to other elements such as an evaporator or a heating element depending on requirement of the passenger.

Further, the HVAC unit 100 may operate in three different modes, such as a fresh air mode, a recirculation air mode, and a partial-recirculation air mode. Generally, while providing cooling function to the passenger cabin, the fresh air mode is energy efficient, whereas the recirculation air mode is energy efficient when the HVAC unit 100 provide heating function to the passenger's cabin. However, to avoid any frosting on the windshields and windows glasses formed due to humidity of the recirculation air, a partial-recirculation air mode is introduced in the HVAC unit 100. In the partial-recirculation air mode, the first inlet 104 and the second inlet 106 are partially open to optimally mix the first airflow and the second airflow, so that frosting of the windows and windshields can be avoided and meantime energy consumption by the HVAC unit 100 is reduced. The first flap 108 and the third door 110 may operate based on temperature of ambient air and humidity level inside the vehicle. The HVAC unit may include a humidity sensor or any other means provided in the passenger's cabin to measure the humidity level of the cabin and provide a signal to an ECU (Electronic Control Unit). Further, a temperature sensor may be provided outer side of the vehicle and exposed to the ambient air to measure temperature of the ambient air and provide a signal to the ECU. The ECU may control the first door 108A, the second door 108B, and the third door 110 based on the signals from the temperature sensor and humidity sensor. Different mode of operation of the HVAC unit 100 is explained with forthcoming figures.

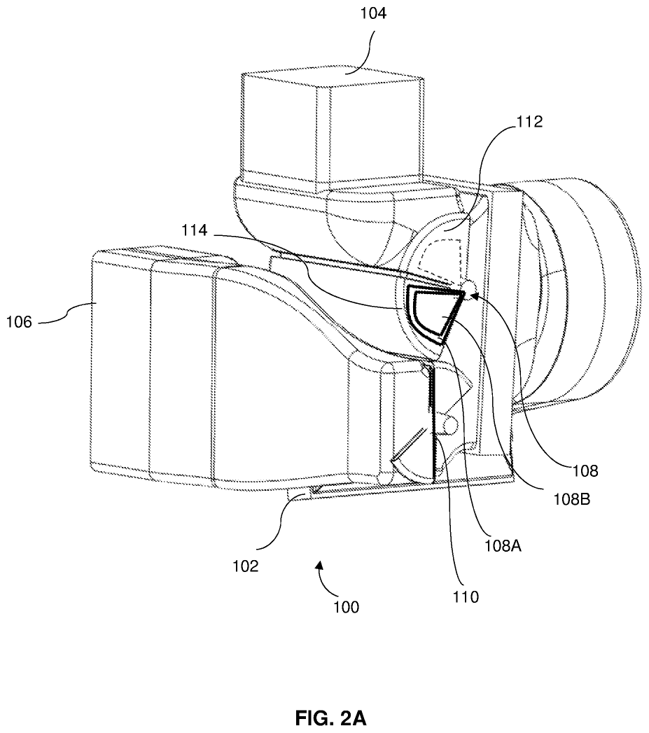

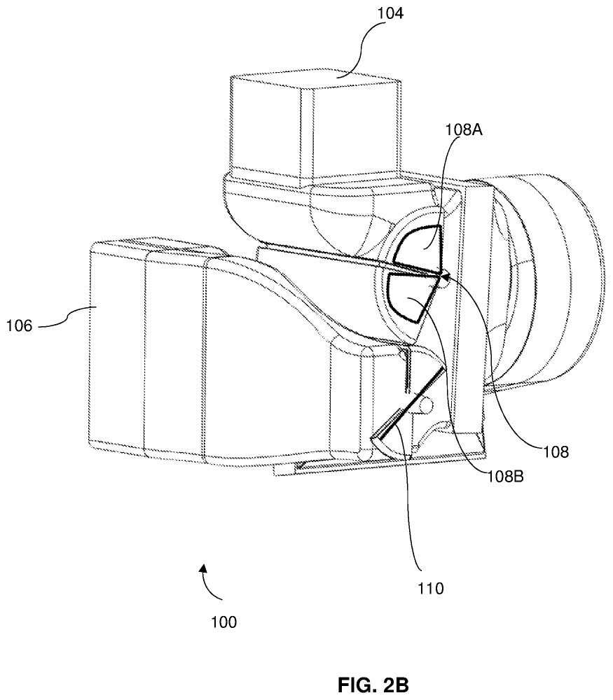

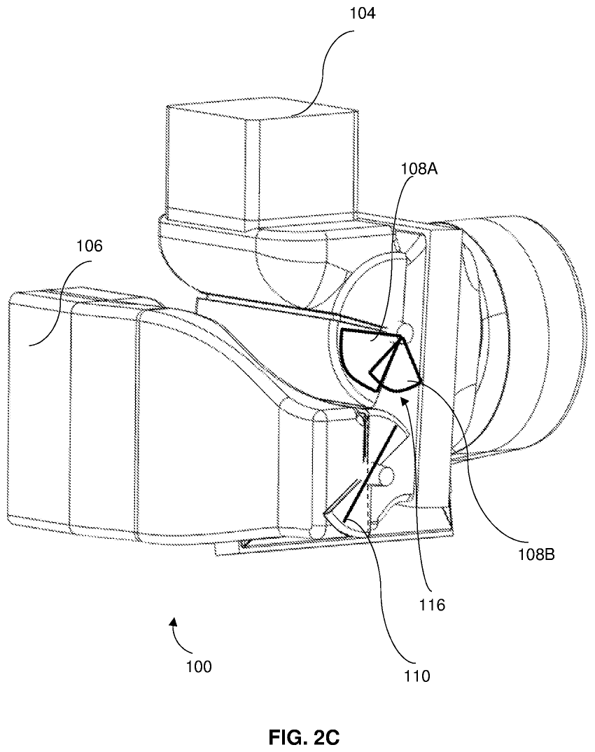

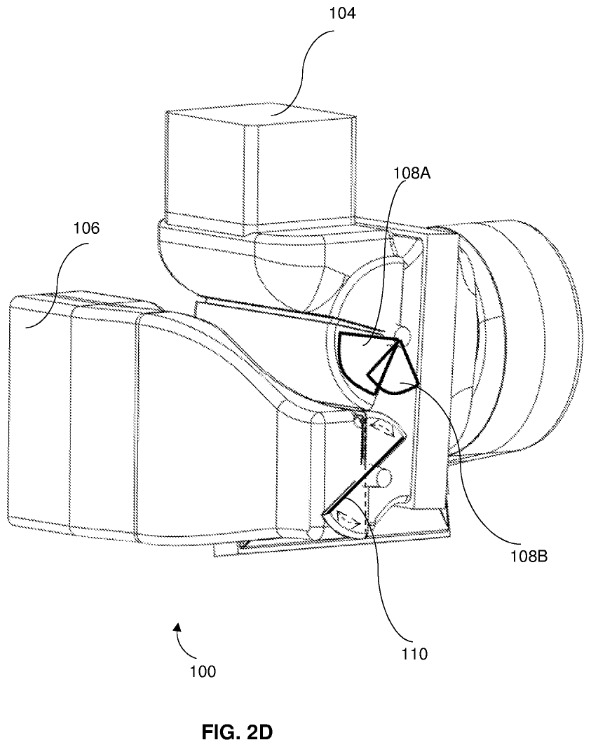

FIG. 2A illustrates a schematic view of the HVAC unit 100 of FIG. 1 when the HVAC unit 100 is operating in the fresh air mode, in accordance with an embodiment of the present invention. In the fresh air mode, the first inlet 104 is opened position to provide the first airflow, can be ambient air, to the housing 102. Meantime, the second inlet 106 is closed position, so that the recirculated airflow is blocked from entering the housing 102. To achieve this, the first door 108A of the first flap 108 is positioned in the first position 112 and the third door 110 is positioned in the closed position, thereby the HVAC unit 100 defines the fresh air mode. Further, the position of the second door 108B of the first flap 108 is not important to define the fresh air mode. The second door 108B can be either of the first position 112 or the third position 116, as it is not affect the first airflow to the housing 102. The first door 108A and the second door 108B may overlap each other when the HVAC unit operating in the fresh air mode. In other words, the first door 108A overlaps the second door 108B when the first door 108A and the second door 108B are in the first position 112. Therefore, the first airflow flow from the first inlet 104 to the blower 120 through the filter 118.

FIG. 2B illustrates a schematic view of the HVAC unit 100 of FIG. 1 when the HVAC unit 100 is operating in the recirculation air mode, in accordance with an embodiment of the present invention. In the recirculation air mode, the first inlet 104 is closed and the second inlet 106 is open, so that the second airflow, i.e., recirculated air from the passenger's cabin, is provided back to the housing 102. To achieve this, the first door 108A of the at least one first flap 108 is moved to the second position 114 and the third door 110 is moved to the open position, thereby the HVAC unit (100) defines the recirculation air mode. Further, the position of the second door 108B of the first flap 108 is not important to define the fresh air mode. The second door 108B can be either of the first position 112 or the third position 116, as it is not affect the second airflow to the housing 102. In one embodiment, the third door 110 being a butterfly door angularly movable to different positions based on requirement. The third door 110 is connected to the second inlet 106 in such a way that the third door 110 can be angularly movable to open the second inlet 106 at different opening levels. As the first door 108a closes the first inlet 104, the second airflow flows to the housing 102.

FIGS. 2C and 2D illustrate schematic view of the HVAC unit 100 of FIG. 1 when the HVAC unit 100 is operating in the partial-recirculation air mode, in accordance with an embodiment of the present invention. In the partial-recirculation air mode, the first airflow and the second airflow are mixed to avoid any frosting on the glass windows and windshields. As the fresh air is mixed with a partial recirculated air, the humidity level of the air entering into the housing 102 is controlled, thereby avoiding above-mentioned problem. To achieve this, the first door 108A is moved to the first position 112, and the second door 108B of the first flap 108 is moved to the third position 116, thereby blocking the air passage between the first inlet 104 and the second inlet 106, and meantime the first inlet 104 remains open. Further, the third door 110 is a partially-open position, where a part of the recirculated air/second airflow is entering into the housing 102. The first airflow and the second airflow may be in different pressure level. In this example, the first airflow is having high pressure and velocity than of the second airflow, so there is a possibility to flow the first airflow to the second inlet 106. To avoid such scenario, the second door 108B moved to the third position 116, so the high pressure first airflow is forced to flow into the filter 118. Further, the angle of opening of the third door 110 is based on humidity content level present the second airflow. In the example shown in FIG. 2C, the third door 110 is moved by a first angle in which the second inlet 106 is opened at X level. In the example shown in FIG. 2D, the third door 110 is moved by a second angle in which the second inlet 106 is opened at X′ level. Further, the angular movement of the third door 110 is completely based on the humidity level of the second airflow. In case the humidity level is more in the second airflow, the angular movement of the third door 110 is less, so that less second airflow enters into the housing 102. In case the humidity level is less in the second airflow, the angular movement of the third door 110 is more, so that more second airflow enters into the housing 102 to optimum airflow into the housing 102. As the second door 108B is blocked the air passage between the first inlet 104 and the second inlet 106, the first airflow and the second airflow having different pressure levels enter into the housing 102 through the filter. Therefore, frosting of the windows, windshields and any such elements are avoided and the energy consumption by the HVAC unit 100 is optimized.

In any case, the invention cannot and should not be limited to the embodiments specifically described in this document, as other embodiments might exist. The invention shall spread to any equivalent means and any technically operating combination of means.

All the above-described embodiments are just to explain the present invention while more embodiments and combinations thereof might exist. Hence, the present invention should not be limited to the above-described embodiments alone.

1. A Heating, Ventilation, and Air-Conditioning unit for a vehicle, comprising:
a housing;
a first inlet provided in the housing for enabling a first airflow into the housing;
a second inlet provided in the housing for enabling a second airflow into the housing;
at least one first flap having a first door and a second door, attached to the first inlet,
wherein the first door is angularly movable with respect to the second door and adapted to move between a first position and a second position to open and close the first inlet respectively, wherein the second door is angularly movable with respect to the first door and adapted to move between the first position and a third position to open and close air passage between the first inlet and the second inlet; and
at least one third door rotatably connected in the second inlet, wherein the at least one third door is movable between a closed position where the second inlet is closed and an at least partially open position where the second inlet is partially open.

2. The Heating, Ventilation, and Air-Conditioning unit as claimed in claim 1, wherein the first door and the second door are barrel doors that have a same axis of rotation.

3. The Heating, Ventilation, and Air-Conditioning unit as claimed in claim 1, wherein the at least one third door is a butterfly door.

4. The Heating, Ventilation, and Air-Conditioning unit as claimed in claim 1, wherein the movement of the at least one third door is based on humidity level of passenger's cabin of the vehicle.

5. The Heating, Ventilation, and Air-Conditioning unit as claimed in claim 1, wherein the first door of the at least one first flap is in the second position and the at least one third door is in the open position when the Heating, Ventilation, and Air-Conditioning unit defining a recirculation air mode.

6. The Heating, Ventilation, and Air-Conditioning unit as claimed in claim 1, wherein the first door of the at least one first flap is in the first position and the at last one third door is in the closed position when the Heating, Ventilation, and Air-Conditioning unit defining a fresh air mode.

7. The Heating, Ventilation, and Air-Conditioning unit as claimed in claim 1, wherein the first door of at least one first flap is in the first position, the second door of the at least one first flap is in the third position and the at least one third door is in a partially open position when the Heating, Ventilation, and Air-Conditioning unit defines a partial-recirculation air mode.

8. The Heating, Ventilation, and Air-Conditioning unit as claimed in claim 5, wherein the first door and the second door of the at least one first flap are overlap with each other when the both first door and the second door of the at least one first flap is in the first position.

9. The Heating, Ventilation, and Air-Conditioning unit as claimed in claim 1, wherein the angular movement of the at least one first flap is based on a temperature of the atmospheric air.

10. The Heating, Ventilation, and Air-Conditioning unit as claimed in claim 1, wherein the second inlet is juxtaposed to the first inlet.

11. The Heating, Ventilation, and Air-Conditioning unit as claimed in claim 1, further comprising a blower adapted to receive air from at least one of the first inlet and the second inlet.

12. A vehicle comprising:
a Heating, Ventilation, and Air-Conditioning (HVAC) unit comprising:
a housing,
first inlet provided in the housing for enabling a first airflow into the housing,
a second inlet provided in the housing for enabling a second airflow into the housing,
at least one first flap having a first door and a second door, attached to the first inlet,
wherein the first door is angularly movable with respect to the second door and adapted to move between a first position and a second position to open and close the first inlet respectively, wherein the second door is angularly movable with respect to the first door and adapted to move between the first position and a third position to open and close air passage between the first inlet and the second inlet, and
at least one third door rotatably connected in the second inlet, wherein the at least one third door is movable between a closed position where the second inlet is closed and an at least partially open position where the second inlet is partially open;
a humidity sensor adapted to measure humidity level of the vehicle compartment; and
a temperature sensor adapted to measure temperature of the atmospheric air.

13. The vehicle as claimed in claim 12, further comprising: an electronic control unit (ECU) adapted to receive the humidity and temperature from the respective humidity sensor and temperature sensor and dynamically control the at least one first flap and the at least one third door.
